(19) United States
(12) Patent Application Publication
(10) Pub. No.: US 2002/0159939 A1
(43) Pub. Date: Oct. 31, 2002

(54) Gas purification system

(75) Inventors: Dick J. Lieftink, Utrecht (NL); Ellart K. De Wit, Utrecht (NL); Joannes M. Der Kinderen, Twello (NL)

Correspondence Address: Joe Hulett, Wong Cabello, Suite 600, 20333 SH 249, Houston, TX, 77070, US

(73) Assignee: Plug Power Inc., Latham, NY

(21) Appl. No.: 10/121,225

(22) Filed: Apr. 12, 2002

Related U.S. Application Data
(60) Provisional application No. 60/287,046, filed on Apr. 27, 2001.

(51) Int. Cl. C01B 17/00; F23J 11/00; B01D 50/00

(52) U.S. Cl. 423/242.1; 423/244.01; 423/244.02; 423/244.09; 423/244.11; 423/244.1; 422/168; 422/171

(57) ABSTRACT

In general, the invention provides methods and associated apparatuses for removing odorant and sulfur compounds from a gas stream such as natural gas. As an example, such systems are typically required by fuel processor systems adapted to convert natural gas into reformate for use in fuel cell systems, where the odorant and sulfur compounds might otherwise poison the fuel processor and fuel cell catalysts Systems under the present invention are based on the use of at least two filtration stages such that the odorant removal function is segregated from the general removal of H₂S.

### CROSS REFERENCE TO RELATED APPLICATIONS

This application claims priority under 35 USC 119(e) from U.S. Provisional Application No. 60/287,046, filed Apr. 27, 2001, naming Lieftink, et al. as inventors, and titled “GAS PURIFICATION SYSTEM.” That application is incorporated herein by reference in its entirety and for all purposes.

### BACKGROUND

The invention generally relates to a technique and apparatus for desulfurizing a hydrocarbon stream.

A fuel cell is an electrochemical device that converts chemical energy produced by a reaction directly into electrical energy. For example, one type of fuel cell includes a polymer electrolyte membrane (PEM), often called a proton exchange membrane, that permits only protons to pass between an anode and a cathode of the fuel cell. At the anode, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

H₂→2H⁺+2e⁻ at the anode of the cell, and

O₂+4H⁺+4e⁻→2H₂O at the cathode of the cell.

A typical fuel cell has a terminal voltage of up to one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other. The plates may include various surface flow channels and orifices to, as examples, route the reactants and products through the fuel cell stack Several PEMs (each one being associated with a particular fuel cell) may be dispersed throughout the stack between the anodes and cathodes of the different fuel cells. Electrically conductive gas diffusion layers (GDLs) may be located on each side of each PEM to act as a gas diffusion media and in some cases to provide a support for the fuel cell catalysts. In this manner, reactant gases from each side of the PEM may pass along the flow channels and diffuse through the GDLs to reach the PEM. The PEM and its adjacent pair are often assembled together in an arrangement called a membrane electrode assembly (MEA).

A fuel cell system may include a fuel processor that converts a hydrocarbon (natural gas or propane, as examples) into a fuel flow for the fuel cell stack. For a given output power of the fuel cell stack, the fuel flow to the stack must satisfy the appropriate stoichiometric ratios governed by the equations listed above. Thus, a controller of the fuel cell system may monitor the output power of the stack and based on the monitored output power, estimate the fuel flow to satisfy the appropriate stoichiometric ratios. In this manner, the controller regulates the fuel processor to produce this flow, and in response to controller detecting a change in the output power, the controller estimates a new rate of fuel flow and controls the fuel processor accordingly.

The fuel cell system may provide power to a load, such as a load that is formed from residential appliances and electrical devices that may be selectively turned on and off to vary the power that is demanded by the load. Thus, the load may not be constant, but rather the power that is consumed by the load may vary over time and abruptly change in steps. For example, if the fuel cell system provides power to a house, different appliances/electrical devices of the house may be turned on and off at different times to cause the load to vary in a stepwise fashion over time.

Fuel cells generally utilize hydrogen as a fuel, and fuel cell systems are known that process natural gas or propane into a hydrogen rich stream (often referred to as reformate) for use as the fuel. Natural gas is a loose term that can describe a variety of hydrocarbon gas compositions which may vary widely, for example, according to geography, temperature, time of year, etc. For example, some sources of natural gas may typically contain about 75% CH₄, 15% ethane (C₂H₆), and 5% other hydrocarbons, such as propane (C₃H₈) and butane (C₄H₁₀). In the U.S., natural gas from municipal utilities may contain the following general composition: 94% methane (CH₄); 3.2% ethane (C₂H₆); 0.7% propane (C₃H₈); 2.6% CO₂+N₂; 0.25˜1 grains/100 ft³ hydrogen sulfide (H₂S); 1.0-10 grains/100 ft³ Mercaptans; 10-20 grains/100 ft³ Total sulfur.

Methane is a colorless, odorless gas with a wide variation in distribution in nature. Methane is not toxic when inhaled, but it can produce suffocation by reducing the concentration of oxygen inhaled. For this reason, trace amounts of odorous organic sulfur compounds are usually added to natural gas in order to provide a detectable odor (e.g., to make gas leaks readily detectible). Such compounds are generally referred to as “odorants”. It will be appreciated that an odorant refers to any compound which is added to a gas to make the gas detectable to humans by smell. Typical odorants mixtures include tertiary butyl mercaptan, (CH₃)₃CSH and dimethyl sulfide, CH₃—S—CH₃. Additional compounds may also be used: tetrahydrothiophene (THT, or “thiophanes”); isopropyl mercaptan; propyl mercaptan; and methyl ethyl sulfide. Additional components may also be present in natural gas, such as carbonyl sulfide (COS), carbon disulfide (CS₂), etc. Similarly, propane fuels may also contain a mixture of components.

The sulfur compounds associated with natural gas, propane, and other fuels (e.g., H₂S, COS) can degrade fuel cell catalysts, as well as the fuel processor catalysts. For this reason, fuel cell systems utilizing such streams generally include a desulfurization process to remove sulfur compounds from such streams. Many other processes also require desulfurization of gas or liquid streams, either to protect catalysts or for other reasons. For example, sulfur may be removed from combustion fuels to prevent formation of sulfur dioxide and other exhaust components that cause acid rain.

There is a continuing need for an arrangement and/or technique to desulfurize gas streams, and to address one or more of the issues discussed above.

### SUMMARY

In general, the invention provides methods and associated apparatuses for removing odorant and sulfur compounds from a gas stream such as natural gas (e.g., removing such compounds to less than 50 parts per billion). As an example, such systems are typically required by fuel processor systems adapted to convert natural gas into reformate for use in fuel cell systems, where the odorant and sulfur compounds might otherwise poison the fuel processor and fuel cell catalysts. Systems under the present invention are based on the use of at least two filtration stages such that the odorant removal function is segregated from the general removal of H₂S. This advantageously enables the size and make-up of each stage to be tailored to a specific application. Some embodiments also provide modular systems allowing individual stages to be replaced independently as they become saturated with odorants and sulfur compounds. Other features and advantages are described herein.

As an example, whereas zeolite and activated carbon materials are often used to filter odorant and sulfur compounds from natural gas, the natural gas (sometimes referred to as “utility gas”) in some areas of Europe, as an example, tends to contain levels of carbonyl sulfide (COS) and other components that are not absorbed by zeolites or activated carbon. In such systems, a second material such as nickel oxide may be required to remove materials such as COS. Such materials are typically expensive relative to more conventional absorbents such as zeolites and activated carbon. However, even in areas where difficult-to-absorb components like COS are present, levels are still generally low enough that only small amounts of the more expensive absorbents are required (as an example, to achieve a one year life as a filter for a given fuel processing application). Since COS absorbents also tend to be suitable for absorbing odorants and H₂S, it is advantageous to use a less expensive material in a primary absorption stage to remove odorants and H₂S in order to conserve the amount of secondary absorbents required for the other sulfur compounds present (e.g., COS).

In the context of this invention, the terms absorption and adsorption may be used interchangeably. In some embodiments, odorants and H₂S can be removed from a gas stream in a first stage, and then the remaining carbonyl sulfide and carbon disulfide is reacted with a catalyst suitable to hydrolyze these components into H₂S. The H₂S is then absorbed into an additional material such as a zeolite or active carbon in a subsequent stage. In one aspect, the invention provides a method of removing sulfur compounds from a gas stream, comprising the following steps: removing an odorant component of a gas in a first step by contacting the gas with a first material; and removing H₂S from the gas in a second step by contacting the gas with a second material different from the first material.

Embodiments of this method can further any of the following details and additional steps, either alone or in combination. The first material can comprise a zeolite (e.g., a type X zeolite). The odorant compound can be at least one of: tetrahydrothiophene, tertiary butyl mercaptan, isopropyl mercaptan, propyl mercaptan, dimethyl sulfide, and methyl ethyl sulfide. The second material can comprise an H₂S absorbent. A further step may include: reacting the gas with a COS hydrolysis catalyst to convert a COS sulfide component of the gas to H₂S after removing the odorant and prior to removing the H₂S in the second step. The COS hydrolysis catalyst can comprise a material selected from the group comprising titania, zirconia, thoria, lanthanide oxide, alumina, ceria, molybdenum oxide, vanadium oxide, manganese oxide, cobalt oxide, iron oxide and nickel oxide. Further steps may also include: heating a third material to a temperature greater than 10° C., wherein the third material is adapted to adsorb H₂S (e.g., a zeolite having a mean pore size less than 10 angstroms); and flowing the gas through the third material prior to contacting the gas with the first material.

Another step may include flowing the gas from the second material through a fourth material adapted to provide a visual indication of H₂S detection. Methods under the invention may also include: maintaining the first material at a first temperature; and maintaining the second material at a second temperature, wherein the first temperature is different from the second temperature. Other methods under the invention may also include: absorbing the odorant component into the first material; and replacing the first material with fresh first material while not replacing the second material. Still other methods under the invention may include: absorbing H₂S into the second material; and replacing the second material with fresh second material while not replacing the first material.

In another aspect, the invention provides an apparatus for removing sulfur compounds from a gas stream. The system includes a first material and a second material, and a conduit having an inlet and an outlet. The conduit provides fluid communication from the inlet to the first material, from the first material to the second material, and from the second material to the outlet (i.e., the gas flows along the conduit through each of the two stages). The first material is suitable for absorbing an odorant compound, and the second material is suitable for absorbing H₂S. The first material can comprise a zeolite, and the first material and second material can be different substances.

Advantages and other features of the invention will become apparent from the following description, drawing and claims.

### DESCRIPTION OF THE DRAWINGS

FIG. 1 shows a flow diagram of a method of removing sulfur compounds from a gas stream.

FIG. 2 shows a flow diagram of a method of removing sulfur compounds from a gas stream.

FIG. 3 shows a schematic diagram of an apparatus for removing sulfur compounds from a gas stream.

FIG. 4 shows a schematic diagram of an apparatus for removing sulfur compounds from a gas stream.

FIG. 5 shows a schematic diagram of an apparatus for removing sulfur compounds from a gas stream.

### DETAILED DESCRIPTION

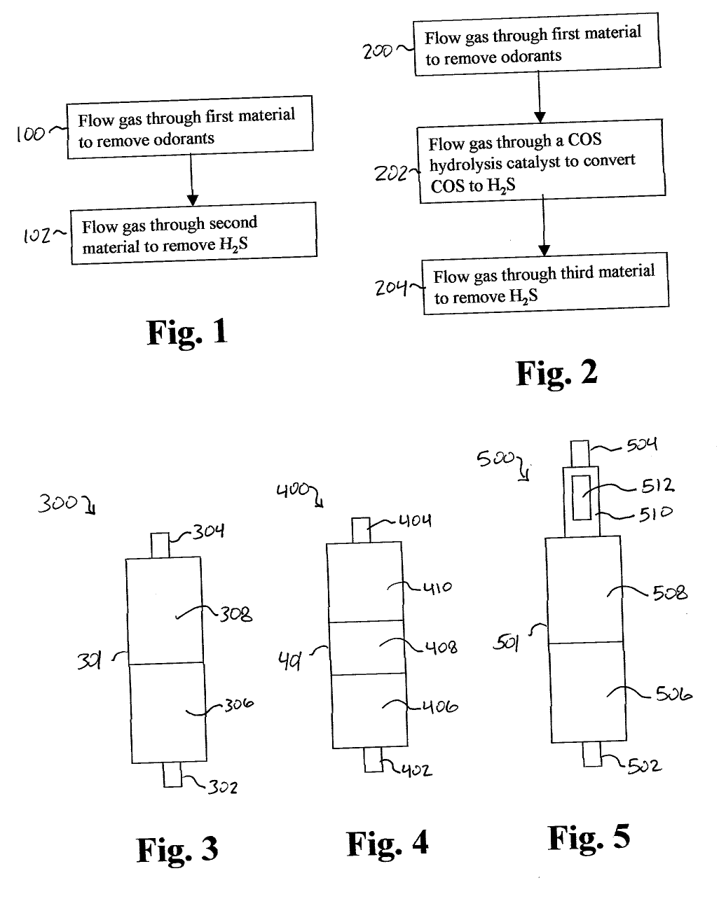

Referring to FIG. 1, a flow diagram is shown of a method of removing sulfur compounds from a gas stream, including the following steps: (100) Flowing gas through a first material to remove odorant components from the gas; and (102) Flowing the gas through a second material to remove H₂S from the gas. Alternatively, referring to FIG. 2, a flow diagram is shown of another method of removing sulfur compounds from a gas stream according to the present invention, including the following steps: (200) Flowing gas through a,first material to remove odorant components from the gas; (202) Flowing the gas through a COS hydrolysis catalyst to convert COS in the gas into H₂S; and (204) Flowing the gas through a third material to remove H₂S from the gas.

Referring to FIG. 3, a schematic diagram is shown of an apparatus 300 for removing sulfur compounds from a gas stream. The system 300 includes a vessel 301 having an inlet 302 and an outlet 304. The vessel 301 includes a first compartment 306 containing a first material, and a second compartment 308 containing a second material. A gas such as natural gas from a utility line is fed through inlet 302. The gas flows up the vessel 301 and exits outlet 304. As an example, outlet 304 may be connected with the inlet of a fuel processor adapted to convert the natural gas into reformate for use by a fuel cell. However, it will be appreciated that the invention is not necessarily limited to this application (e.g., it can also be used to de-sulfurize other types of gasses and for other applications).

The first material in compartment 302 is a material suitable for absorbing odorant compounds from the gas. As an example, where the gas is methane and contains sulfur-based odorants, the first material can be a type X zeolite or activated carbon, either in monolith or pellet form, as examples. Since it may also be necessary to remove COS and other compounds not absorbed by the first material, the second material is provided in the second compartment 308 as a second filtration stage. As an example, nickel materials (e.g., NiO) are suitable materials. The second material can also be another zeolite. For example, where CO₂ is present in the gas stream and a type X zeolite is used as the first material, the CO₂ can react in the pores of the zeolite with H₂S to form COS. To prevent such COS formation, a zeolite may be selected as the second material that has a pore size small enough (e.g., smaller than 10 angstroms) to prevent CO₂ from being absorbed.

As previously mentioned, one aspect of the invention is that with multiple filtration stages, it may be possible to replace individual vessel compartments or materials (e.g., at service intervals) without having to replace the entire de-sulfurization vessel. The individual compartments and/or the capacity of the material quantities provided in the vessel can also be tailored to a given application. Another feature of the invention may include an electric heater associated with the first material to heat the first material up during a cold start (e.g., below 20° C. or 0° C., as examples). It will be appreciated that the effectiveness of various materials to absorb gas components may be diminished at relatively low temperatures. Without such an arrangement, the start-up time of a system may be prolonged while the de-sulfurization bed heats up with the rest of the system.

As another example, a cold-start module (not shown) may be associated with any of the systems described herein (e.g., 300, 400, 500). In such a cold start module, an electric heater can be activated to provide heat to an adsorption material that is only used during start-up. For example, a small quantity of a highly active, less-temperature dependent material such as nickel can be used in the cold-start module. The quantity need only be relatively small since the cold-start module is only used during start-up. When the system reaches a desired temperature, the gas flow can be by-passed from the cold-start module. In some embodiments, the material used in the cold start module is active enough that the electric heater is not necessary.

Referring to FIG. 4, a schematic diagram is shown of another apparatus 400 for removing sulfur compounds from a gas stream. The system 400 includes a vessel 401 having an inlet 402 and an outlet 404. The vessel 401 includes a first compartment 406 containing a first material, a second compartment 408 containing a second material, and a third compartment 410 containing a third material. In this embodiment, the gas (methane in this example) flows through inlet 402 and through material 406, which is a bed of zeolite pellets that remove the odorant components of the gas (mercaptans, THT, etc.). The gas, which contains water vapor, flows into material 408, which is a COS hydrolysis catalyst (The COS is reacted with water to produce H₂S: COS+H₂O→CO₂+H₂S). One suitable COS hydrolysis catalysts is the SCOS catalyst available from Elf Atofina. Other suitable materials include titania, zirconia, thoria, lanthanide oxide, alumina, ceria, molybdenum oxide, vanadium oxide, manganese oxide, cobalt oxide, iron oxide and nickel oxide.

In some embodiments, the water for this reaction may be supplied by injecting water into the vessel at a location associated with the second material 408. The gas then flows to a third material 410 that absorbs the H₂S produced in the second material. Since CO₂ is produced by the hydrolysis reaction of COS, and as previously discussed, since CO₂ can react with H2S in the pores of a zeolite to form COS, where the third material is a zeolite, it may be desirable the third material have a pore size small enough (e.g., <10 angstroms) such that the CO₂ is not absorbed.

Referring to FIG. 5, a schematic diagram is shown of an apparatus 500 for removing sulfur compounds from a gas stream. The system 500 includes a vessel 501 having an inlet 502 and an outlet 504. The vessel 501 includes a first compartment 506 containing a first material, and a second compartment 508 containing a second material. A third compartment 510 is positioned between the second compartment 508 and the outlet 504. The third compartment contains a third material and includes a window 512.

The third material is selected to provide a visual indication when contacted with sulfur compounds. As an example, the gas may be passed through a material containing lead acetate as it exits the vessel 501 through outlet 504. As known in the art, lead acetate, which is normally white, will turn black when contacted with sulfur compounds as it is converted to lead sulfide. Other suitable materials are known in the art. This visual indication can be observed through window 512. In this way, the system 500 provides a visual indication of when sulfur begins “breaking through”. In other words, a visual indication is provided that the absorbent materials in the system need to be refreshed or replaced (e.g., a service call).

While the invention has been disclosed with respect to a limited number of embodiments, those skilled in the art, having the benefit of this disclosure, will appreciate numerous modifications and variations therefrom. It is intended that the invention covers all such modifications and variations as fall within the true spirit and scope of the invention.

What is claimed is:

1. A method of removing sulfur compounds from a gas stream, comprising:
removing an odorant component of a gas in a first step by contacting the gas with a first material; and
removing H₂S from the gas in a second step by contacting the gas with a second material different from the first material.

2. The method of claim 1, wherein the first material comprises a zeolite.

3. The method of claim 1, wherein the first material comprises a type X zeolite.

4. The method of claim 1, wherein the odorant compound comprises a material selected from the group comprising tetrahydrothiophene, tertiary butyl mercaptan, isopropyl mercaptan, propyl mercaptan, dimethyl sulfide, and methyl ethyl sulfide.

5. The method of claim 1, wherein the second material comprises an H₂S absorbent.

6. The method of claim 1, further comprising:
reacting the gas with a COS hydrolysis catalyst to convert a COS sulfide component of the gas to H₂S after removing the odorant and prior to removing the H₂S in the second step.

7. The method of claim 6, wherein the COS hydrolysis catalyst comprises a material selected from the group comprising titania, zirconia, thoria, lanthanide oxide, alumina, ceria, molybdenum oxide, vanadium oxide, manganese oxide, cobalt oxide, iron oxide and nickel oxide.

8. The method of claim 7, further comprising:
heating a third material to a temperature greater than 10° C., wherein the third material is adapted to adsorb H₂S; and
flowing the gas through the third material prior to contacting the gas with the first material.

9. The method of claim 1, further comprising:
flowing the gas from the second material through a fourth material adapted to provide a visual indication of H₂S detection.

10. The method of claim 1, further comprising:
maintaining the first material at a first temperature; and
maintaining the second material at a second temperature, wherein the first temperature is different from the second temperature.

11. The method of claim 1, further comprising:
absorbing the odorant component into the first material; and
replacing the first material with fresh first material while not replacing the second material.

12. The method of claim 1, further comprising:
absorbing H₂S into the second material; and replacing the second material with fresh second material while not replacing the first material.

13. The method of claim 1, further comprising:
flowing the gas through a cold-start material comprising nickel during a system start-up step;
bypassing the gas away from the cold-start material when a temperature of the first material rises to a predetermined level.

14. An apparatus for removing sulfur compounds from a gas stream, comprising:
a first material and a second material;
a conduit having an inlet and an outlet, the conduit providing fluid communication from the inlet to the first material, the conduit providing fluid communication from the first material to the second material, and the conduit providing fluid communication from the second material to the outlet;
wherein the first material is suitable for absorbing an odorant compound; and
wherein the second material is suitable for absorbing H₂S.

15. The apparatus of claim 14, wherein the first material comprises a zeolite.

16. The apparatus of claim 14, wherein the first material and second material are different substances.

17. The apparatus of claim 14, wherein the odorant compound comprises a material selected from the group comprising tetrahydrothiophene, tertiary butyl mercaptan, isopropyl mercaptan, propyl mercaptan, dimethyl sulfide, and methyl ethyl sulfide.

18. The apparatus of claim 14, wherein the second material is a COS hydrolysis catalyst.

19. The apparatus of claim 18, wherein the COS hydrolysis catalyst comprises a material selected from the group comprising titania, zirconia, thoria, lanthanide oxide, alumina, ceria, molybdenum oxide, vanadium oxide, manganese oxide, cobalt oxide, iron oxide and nickel oxide.

20. The apparatus of claim 19 further comprising a third material adapted to receive a flow of the gas stream from the second material, wherein the third material is a zeolite material having a mean pore size less than 10 angstroms.

21. The apparatus of claim 14, further comprising an electric heater adapted to selectively heat the first material.

22. An apparatus for removing sulfur compounds from a gas stream, comprising:
a first stage and a second stage;
a conduit having an inlet and an outlet, the conduit providing fluid communication from the inlet to the first stage, from the first stage to the second stage, and from the second stage to the outlet;
wherein the first stage comprises a zeolite material; and
wherein the second stage comprises a material selected from the group comprising H₂S absorbents and COS hydrolysis catalysts.

23. The apparatus of claim 22, wherein the first stage is removeably connected to the conduit, and wherein the second stage is removeably connected to the conduit.
